(19) United States
(12) Patent Application Publication
(10) Pub. No.: US 2024/0311902 A1
(43) Pub. Date: Sep. 19, 2024

(54) SYSTEMS AND METHODS FOR CREATING, STORING AND MODIFYING NON-FUNGIBLE ASSETS AND METADATA

(71) Applicant: Mojoverse, Inc., Conway, MA (US)

(72) Inventors: Michael E. Levine, Conway, MA (US); Jure Bogunovic, Split (HR)

(73) Assignee: Mojoverse, Inc., Conway, MA (US)

(21) Appl. No.: 18/602,823

(22) Filed: Mar. 12, 2024

Related U.S. Application Data
(60) Provisional application No. 63/451,701, filed on Mar. 13, 2023.

(51) Int. Cl. G06Q 30/0601

(52) U.S. Cl. CPC G06Q 30/0643

(57) ABSTRACT

A method for generating a non-fungible token (NFT) includes maintaining, by a set of node devices, a distributed ledger and a wardrobe smart contract that corresponds to one or more initial NFT models. A set of node devices execute a wardrobe smart contract in response to a frontend calling function. The wardrobe smart contract assigns one or more outcome NFT models to a user account of a user on the distributed ledger based on one or more processes.

### CROSS-REFERENCE TO RELATED APPLICATION

The present application claims the benefit of provisional application No. 63/451,701, filed Mar. 13, 2023.

### FIELD OF TECHNOLOGY

The present disclosure relates to non-fungible assets and metadata, and more particularly, to creating, storing, and modifying non-fungible assets and metadata.

### BACKGROUND

Non-fungible assets/tokens, also referred to as NFTs, have become increasingly popular. With many built on smart contracts via the Ethereum blockchain, every non-fungible asset is unique in its code and can be tracked accordingly via an associated blockchain ledger. While these NFTs may be intrinsically valuable as collectibles in and of themselves, they may represent further value when associated with digital art, gifs, music, trading cards, game pieces, or events that are traded or otherwise engaged via an NFT marketplace.

### SUMMARY

In one aspect of the present disclosure is a computer-implemented method for generating a non-fungible token (NFT), comprising: maintaining, by a set of node devices, a distributed ledger and a wardrobe smart contract that corresponds to one or more initial NFT models. The method further includes executing, by a set of node devices, the wardrobe smart contract in response to a frontend calling function, wherein the one or more initial NFT models are generated prior to the frontend calling function. The method also includes processing one or more one or more initial accessories corresponding to the one or more initial NFT models. The method further includes processing one or more additional accessories for one or more replacement NFT models in response to the frontend calling function. The method further includes receiving, by the wardrobe smart contract, an equipping request from a user account associated with a user. The method also incudes determining, by the wardrobe smart contract, whether the equipping request is valid. According to the method, if the equipping request is valid, the wardrobe smart contract equips the one or more additional accessories to the one or more replacement NFT models to generate one or more outcome NFT models. The method also includes sending unassigned NFTs, including one or more initial NFT models, to one or more addresses. The method also includes assigning, by the wardrobe smart contract, the one or more outcome NFT models to the user account of the user on the distributed ledger.

According to some aspects of the method, determining whether the equipping request is valid, processing one or more initial accessories corresponding to the one or more initial NFT models, processing one or more additional accessories for one or more replacement NFT models in response to the frontend calling function, generating one or more outcome NFT models, and sending unassigned NFTs includes a single transaction. According to some aspects of the method, the one or more initial, replacement, and outcome NFT models include a shared plurality of different types of NFT models. According to some aspects of the method, the one or more replacement NFT models are generated prior to the frontend calling function. According to some aspects of the method, the one or more additional accessories are generated in response to the frontend calling function.

According to some aspects of the method, the one or more additional accessories for one or more replacement NFT models are transferred from the user account associated with a user. According to some aspects of the method, the wardrobe smart contract includes a plurality of one or more additional accessories to replace one or more of initial accessories in combination with the one or more initial NFT models if the equipping request is valid. According to some aspects of the method, the equipping request is determined to be valid by the wardrobe smart contract by checking that a current block's timestamp is after a provided deadline by a backend nonce function. According to some aspects of the method, the one or more addresses includes one or more burn addresses. According to some aspects of the method, the one or more addresses includes one or more smart contracts. According to some aspects of the method, the one or more initial accessories and one or more additional accessories are NFTs.

Another aspect of the present disclosure includes a computer-implemented system, comprising: a digital processing device comprising: at least one processor, an operating system configured to perform executable instructions, a memory, and a computer program including instructions executable by the digital processing device to perform a method for generating a non-fungible token (NFT). This method of the system comprises: maintaining, by a set of node devices, a distributed ledger and a wardrobe smart contract that corresponds to one or more initial NFT models. The method of the system further includes executing, by a set of node devices, the wardrobe smart contract in response to a frontend calling function, wherein the one or more initial NFT models are generated prior to the frontend calling function. The method of the system also includes processing one or more one or more initial accessories corresponding to the one or more initial NFT models. The method of the system further includes processing one or more additional accessories for one or more replacement NFT models in response to the frontend calling function. The method of the system further includes receiving, by the wardrobe smart contract, an equipping request from a user account associated with a user. The method of the system also incudes determining, by the wardrobe smart contract, whether the equipping request is valid. According to the method of the system, if the equipping request is valid, the wardrobe smart contract equips the one or more additional accessories to the one or more replacement NFT models to generate one or more outcome NFT models. The method of the system also includes sending unassigned NFTs, including one or more initial NFT models, to one or more addresses. The method of the system also includes assigning, by the wardrobe smart contract, the one or more outcome NFT models to the user account of the user on the distributed ledger.

According to some aspects of the system, determining whether the equipping request is valid, processing one or more initial accessories corresponding to the one or more initial NFT models, processing one or more additional accessories for one or more replacement NFT models in response to the frontend calling function, generating one or more outcome NFT models, and sending unassigned NFTs includes a single transaction. According to some aspects of the system, the one or more initial, replacement, and outcome NFT models include a shared plurality of different types of NFT models. According to some aspects of the system, the one or more replacement NFT models are generated prior to the frontend calling function. According to some aspects of the system, the one or more additional accessories are generated in response to the frontend calling function.

According to some aspects of the system, the one or more additional accessories for one or more replacement NFT models are transferred from the user account associated with a user. According to some aspects of the system, the wardrobe smart contract includes a plurality of one or more additional accessories to replace one or more of initial accessories in combination with the one or more initial NFT models if the equipping request is valid. According to some aspects of the system, the equipping request is determined to be valid by the wardrobe smart contract by checking that a current block's timestamp is after a provided deadline by a backend nonce function. According to some aspects of the system, the one or more addresses includes one or more burn addresses. According to some aspects of the system, the one or more addresses includes one or more smart contracts. According to some aspects of the system, the one or more initial accessories and one or more additional accessories are NFTs.

Any two or more of the features described in this specification, including in this summary section, may be combined to form implementations not specifically described in this specification.

The details of one or more implementations are set forth in the accompanying drawings and the following description. Other features and advantages will be apparent from the description and drawings, and from the claims.

### BRIEF DESCRIPTION OF THE DRAWINGS

FIG. 1 is a system diagram showing example components typically incorporated in at least some of the computer systems, devices, and methods of the present disclosure;

FIG. 2 is a system diagram showing an exemplary implementation of the system 100 of FIG. 1, according to the present disclosure;

FIG. 3 is a flowchart diagram of exemplary processes within the system of FIG. 2;

FIG. 4 is a flowchart diagram including a more detailed overview of exemplary processes within the system of FIG. 3;

FIG. 5 is a block diagram of an exemplary validation process according to the present disclosure;

FIG. 6 is a block diagram of an exemplary generation process following the exemplary validation process of FIG. 5; and

FIGS. 7A-7C are image renderings of exemplary NFT models, prior and following the addition of one or more accessories.

Like reference numerals in different Figures indicate like elements.

### DETAILED DESCRIPTION

Non-fungible assets/tokens, often referred to as NFTs, are blockchain-based tokens that each represent a unique asset like a piece of art, digital content, or media. An NFT can be thought of as an irrevocable digital certificate of ownership and authenticity for a given asset, whether digital or physical. Accordingly, the metadata of NFTs, often depicted as accompanying images/art, is often static.

The subject disclosure is directed to creating, storing, and modifying non-fungible assets and metadata which are inherently non-static. This can include a user customizing the images/art of their NFT, and thereby, the underlying metadata, to produce any number of infinite new metadata combinations and accompanying images/art. This process can be applied to two-dimensional (2D) or three-dimensional (3D) models representing respective underlying NFTs.

In implementations, an initial NFT model can have initial accessories, represented via the images/art of the respective NFT. In some implementations, the initial NFT model will be tied to a blockchain smart contract, which can have one or more immutable properties. A user can choose to equip, unequip, or otherwise customize one or more additional accessories on the initial base model, resulting in changes to both the non-fungible asset and metadata represented via images/art. These additional accessories, for the purposes of the present disclosure, be processed alongside one or more replacement NFT models (in the mold of the initial NFT model) to generate one or more outcome NFT models. These accessories can provide utility to a user's NFT model cosmetically, as part of gameplay or other strategic application within an environment, or a potential future user based on aesthetics, rarity, or other like considerations.

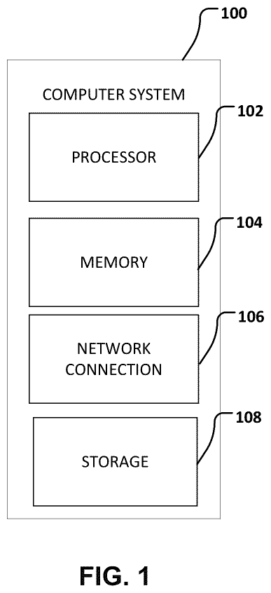

FIG. 1 is a block diagram showing some of the components typically incorporated in at least some of the computer systems, devices, and methods of the present disclosure. In implementations, these computer systems 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various implementations, the computer systems and devices may include each of the following: a processor 102 for executing computer programs and/or training or applying machine learning models, such as a CPU, GPU, TPU, NNP, FPGA, or ASIC; a computer memory 104 for storing programs and data while they are being used, including the facility and associated data, an operating system including a kernel, and device drivers; a network connection 106 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like; and a persistent storage device 108, such as a hard drive or flash drive for persistently storing programs and data. While the systems and methods configured as described above are typically used to support operations according to the present disclosure, those skilled in the art will appreciate that these operations may be implemented using devices of various types and configurations, and having various components.

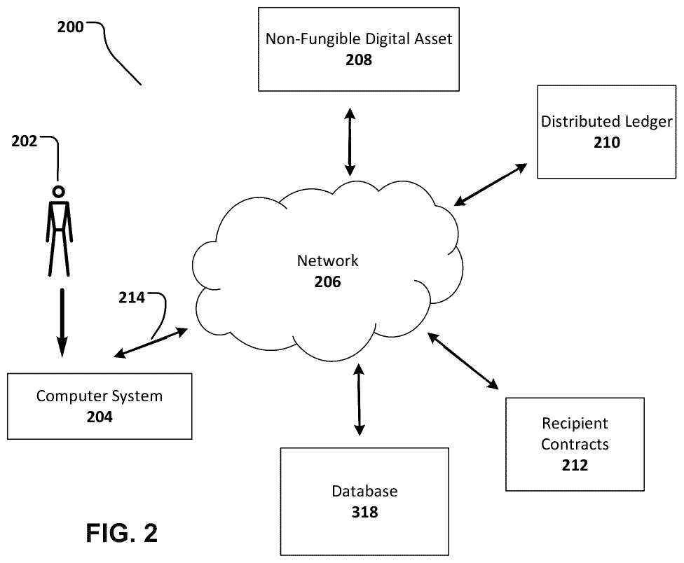

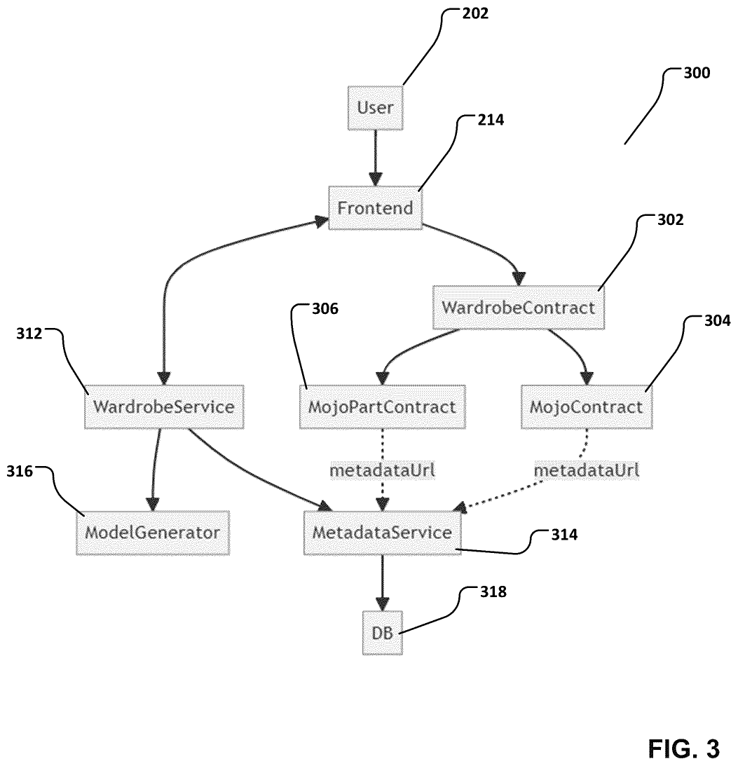

FIG. 2 is a diagram showing an exemplary implementation 200 of the system 100 of FIG. 1 according to the present disclosure. Additional details about their interactions are discussed below in connection with FIGS. 3-7C. As shown in FIG. 2, implementation 200 includes user 202 in communication with computer system 204, which is communicatively connected to recipient contracts 212 and Database 318 by way of network 206. Computer system 204, Database 318, and/or recipient contracts 212 may be implemented by any suitable computing device or combination of computing devices as may serve a particular implementation. For example, computer system 204, Database 318, and/or recipient contracts 212 may be implemented by desktop computers, laptop computers, smartphones, and/or any other suitable type of computing device. System 100 may be implemented by computer system 204, Database 318, and/or recipient contracts 212. Alternatively, system 100 may be distributed across computer system 204, Database 318, recipient contracts 212, and/or any other suitable computer system. Computer system 204, Database 318, and recipient contracts 212 may communicate using any communication platforms and technologies suitable for transporting data and/or communication signals, including known communication technologies, devices, media, and protocols supportive of remote communications, examples of which include, but are not limited to, data transmission media, communications devices, and data transmission protocols.

Network 206 may include, but is not limited to, one or more wireless networks (Wi-Fi networks), wireless communication networks, mobile telephone networks (e.g., cel-lular telephone networks), mobile phone data networks, broadband networks, narrowband networks, the Internet, local area networks, wide area networks, live television transmission networks, and any other networks capable of carrying media content, data, and/or communications signals between computer system 204, Database 318, and recipient contracts 212. Communications between computer system 204, Database 318, and recipient contracts 212 may be transported using any one of the above-listed networks, or any combination or sub-combination of the above-listed networks. Alternatively, computer system 204, Database 318, and recipient contracts 212 may communicate in another way such as by one or more direct connections between computer system 204 and recipient contracts 212.

Computer system 204 may be owned or operated by user 202, who may initiate a request via signed message 214, such as a frontend calling function, to distributed ledger 210, Database 318, and/or recipient contracts 212 via network 206. In order to access and/or govern operations relating to one or more non-fungible tokens (NFTs), such as non-fungible digital asset 208, in some implementations, computer system 204 may implement a digital wallet application that may be configured to perform one or more of the operations described herein. For example, such a digital wallet application, such as a user/player wallet, may store keys (e.g., a public/private key pair) associated with non-fungible digital asset 208, generate a nonce, maintain a list of non-fungible digital assets owned by user 202, and/or perform any other suitable operation(s) once user 202 provides instructions to Database 318, and subsequently, recipient contracts 212, via one or more prompts made via computer system 204, such as calling function 214.

Non-fungible digital asset 208 may be stored in any suitable manner and at any suitable location as may serve a particular implementation. In certain examples, non-fungible digital asset 208 may be stored remotely from computer system 204 and may be accessible by computer system 204 by way of network 206. For example, non-fungible digital asset 208 may be hosted at a server, such as Database 318, that is remote from computer system 204. Computer system 204, for example, may implement a digital wallet application that stores keys that are usable to access and/or manipulate non-fungible digital asset 208 wherever it is stored. For example, the keys may be used to access non-fungible digital asset 208 at a network address associated with non-fungible digital asset 208 and hosted by the server, and may be in communication with one or more game/administrator wallets in communication with recipient contracts 212. Such a server may be implemented as part of computer system 204, Database 318, recipient contracts 212, or may be a third-party server that is remote from computer system 204, Database 318, and recipient contracts 212. In certain alternative implementations, the keys stored by a digital wallet application may be used to access non-fungible digital asset 208 from a local storage device of computer system 204. According to some implementations, these one or more non-fungible digital assets 208 can include base NFT models and/or NFT accessories for the base NFT models. As will be discussed further, these base NFT models can exist in initial, replacement, and/or outcome states as the systems and methods described herein operate. In this way, the NFT accessories can also exist in initial and/or additional states, as the systems and methods described herein operate.

As shown in FIG. 2, computer system 204 may send signed message 214 in any suitable manner (e.g., by way of network 206) to recipient contracts 212. For example, signed message 214 may be sent in the form of text and/or like commands etc. In this way, computer system 204 may access distributed ledger 210 while in communication with recipient contracts 212. According to some implementations, distributed ledger 210 is configured to store ownership information associated with non-fungible digital asset 208. For example, one or more node devices may assist to maintain consensus and proper decentralized functioning of distributed ledger 210. Distributed ledger 210 may correspond to any suitable type of distributed record as may serve a particular implementation. For example, distributed ledger 210 may correspond to a distributed ledger that is implemented by blockchain in certain examples. Although distributed ledger 210 is shown as being separate from computer system 204, Database 318, and recipient contracts 212, it is understood that a copy of distributed ledger 210 may be stored in any suitable storage device associated with either computer system 204, Database 318, recipient contracts 212, and/or any other suitable computer system. Alternatively, distributed ledger 210 may be distributed across computer system 204, Database 318, recipient contracts 212, and/or any other suitable computer system. According to some implementations, the ownership information stored in distributed ledger 210 may include any suitable information associated with non-fungible digital asset 208. For example, the ownership information may indicate which user owns non-fungible digital asset 208, which user or users are authorized to access and/or engage with recipient contracts 212 to manipulate one or more non-fungible digital assets 208, and/or any other suitable information.

As shown in FIG. 2, example system 200 further includes recipient contracts 212. Recipient contracts 212 may include one or more smart contracts in communication with computer system 204, Database 318, non-fungible digital asset 208, and/or distributed ledger 210 via network 206. For example, these recipient contracts 212 may control and/or facilitate changes to the one or more non-fungible digital assets 208, validate one or more actions initiated by computer system 204, process data related to system 200 and its respective components, and/or generate additional one or more non-fungible digital assets 208. According to some implementations, these recipient contracts 212 can include WardrobeContract 302, a modable contract, such as MojoContract 304, a part contract, such as MojoPartContract 306, and/or minter/generator contracts 316, such as LazyPartsMojoMinter 308 and/or PartMinter 310. Recipient contracts 212 may further include services, such as WardrobeService 312 and MetadataService 314, which relate to functions effected by aforementioned recipient contracts 212.

FIG. 3 shows an example process diagram 300 of the system 200 of FIG. 2 as computer system 204 initiates one or more changes to one or more non-fungible digital assets 208 via network 206. In some implementations, this includes creating, storing, and modifying non-fungible assets and/or metadata 208. For example, a smart contract, such as recipient contracts 212, is programmed to execute instructions stored on a blockchain, such as distributed ledger 210, with metadata relating to one or more non-fungible digital assets 208 hosted on “Web2” traditional cloud servers. Then, one or more smart contracts can merge, and unmerge, to, in implementations, 1) modify, and/or 2) burn and/or store the original non-fungible digital asset 208 while creating a new and/or altered non-fungible digital asset 208. These processes can be initiated at any time by user 202 via computer system 204, or otherwise occur during scheduled events by recipient contracts 212.

More specifically, if user 202 desires to manipulate one or more of their non-fungible digital assets 208, user 202 can initiate a request via frontend calling function 214 of computer system 204 to engage with WardrobeContract 302 and/or WardrobeService 312. According to some implementations, WardrobeContract 302 relates to a smart contract which facilitates equipment changes relating to the one or more of their non-fungible digital assets 208. WardrobeContract 302, following a determination that the request 214 is valid by WardrobeService 312, may engage with model generator contracts 316, which can include LazyPartsMojoMinter 308 and/or PartMinter 310, to generate one or more outcome NFT models. For example, this generation can include introducing one or more additional accessories alongside a replacement NFT model of the initial NFT model, replacing one or more initial accessories as included with an initial NFT model to generate a new, outcome NFT model. According to some implementations, MojoPartContract 306 and/or MojoContract 304 can further alter one or more non-fungible digital assets 208. Altering one or more non-fungible digital assets 208 can relate to introducing changes in respective metadata, enabled by MetadataService 314. These changes may be reflected in Distributed Ledger 210 and/or Database 318. Alternatively, Database 318 may be a separate server reflecting changes made according to the systems and methods described herein, and as also recorded in Distributed Ledger 210. Database 318 may include a backend database configured to receive instructions from user 202 via frontend calling functions 214 while accessing, for example, a website via computer system 204. For example, user 202 may access Database 318 via computer system 204 when reviewing NFT models and/or initiating additions, subtractions, and/or other changes to the accessories relating to the one or more NFT models via the methods and systems described herein.

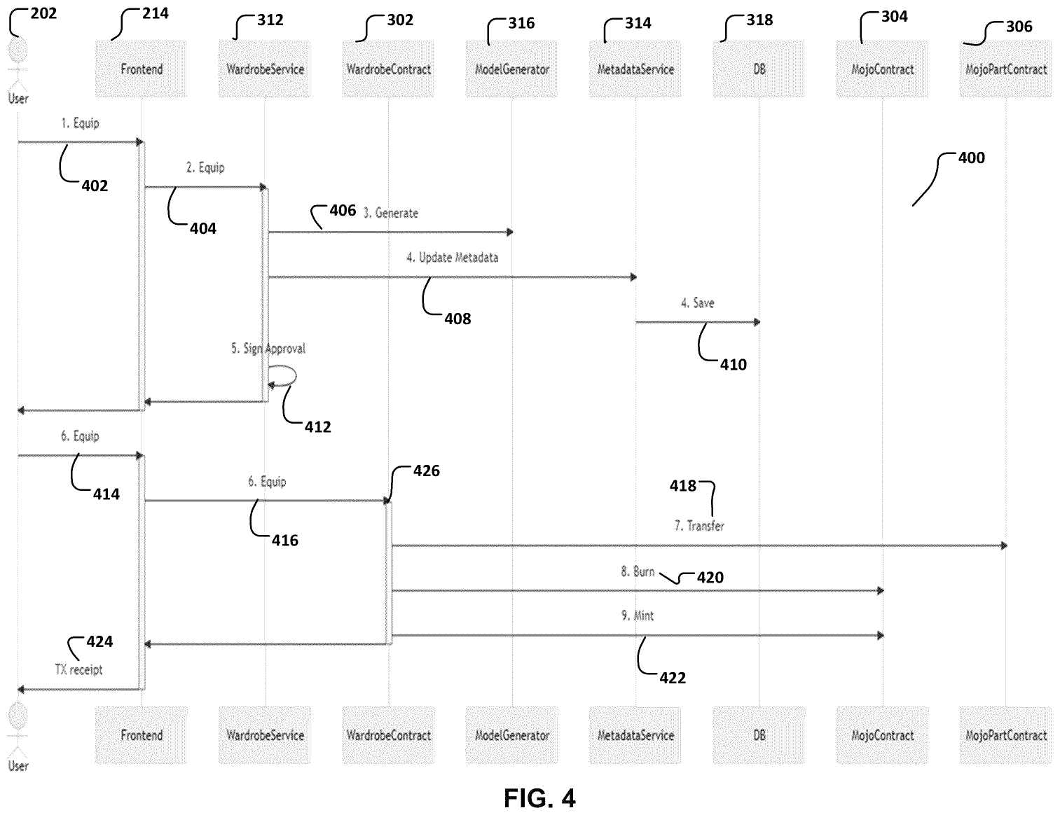

More specifically, FIG. 4 provides a flowchart diagram 400 including a more detailed example of process 300 as introduced in FIG. 3. Here, a user 202 according to the systems and methods of the present disclosure can, through the frontend 214, sign/authorize, one or more approval transactions to initiate the process of assigning the one or more outcome NFT models to the user 202 on the distributed ledger 210. According to the implementations, this can authorize a smart contract relating to, for example, modifying a “wardrobe” accessory, to transfer the one or more initial NFT models prior to creating, storing, and/or modifying the non-fungible assets 208 and/or associated metadata.

According to the example process 400 in FIG. 4, a first event includes a user 202 initiating a change to one or more additional accessories to their one or more initial NFT models via a frontend calling function 214; here, this includes “equipping”, or adding an additional accessory, however, this process may apply to any such dynamic between one or more accessories and one or more NFT models. As previously introduced, this may be enabled via a computer system, such as computer system 204, and may include single, or multiple, aggregated equipping request transactions. According to some implementations, when an accessory is added to an NFT model, it is removed from the wallet of user 202, and when it is removed from an NFT model, it is added back to the wallet of user 202. For example, when user 202 initiates the addition of one or more additional accessories to their one or more initial NFT models via computer system 204, WardrobeContract 302 triggers a transfer to change the ownership of one or more initial accessories from the user 202 to the WardrobeContract 302 itself. In some implementations, when a user 202 removes one or more initial accessories from an initial NFT model, the WardrobeContract 302 triggers a transfer to change the ownership of the one or more initial accessories from the WardrobeContract 302 to the user 202, returning the one or more initial accessories to their respective user/player wallet as recorded via the distributed ledger 210. This dynamic can ensure that all equipped accessories relating to one or more NFT models remain in the custody of the WardrobeContract 302, which prevents the user 202 from selling or transferring the accessories while those accessories are equipped to one or more NFT models. In this way, as accessories can be removed from NFT models by the owner of the one or more accessories and NFT models, transferring and/or selling an NFT model bearing one or more accessories means that those accessories are also, effectively, transferred, and do not require separate transaction sales and/or transfers. The ownership of the accessories while in the custody of the WardrobeContract 302 can be tracked through identification on the distributed ledger 210 relating to each NFT model. Since the identification can be a hash of different data, parts of which can include identification relating to respective accessories, the WardrobeContract 302 can always know which accessories belong to which NFT model(s). The equipped one or more additional accessories may only refer to the “on-chain” (via distributed ledger 210) accessories, as the one or more NFT models may still have accessories that are not reflected on-chain; these may be visible only in their respective metadata.

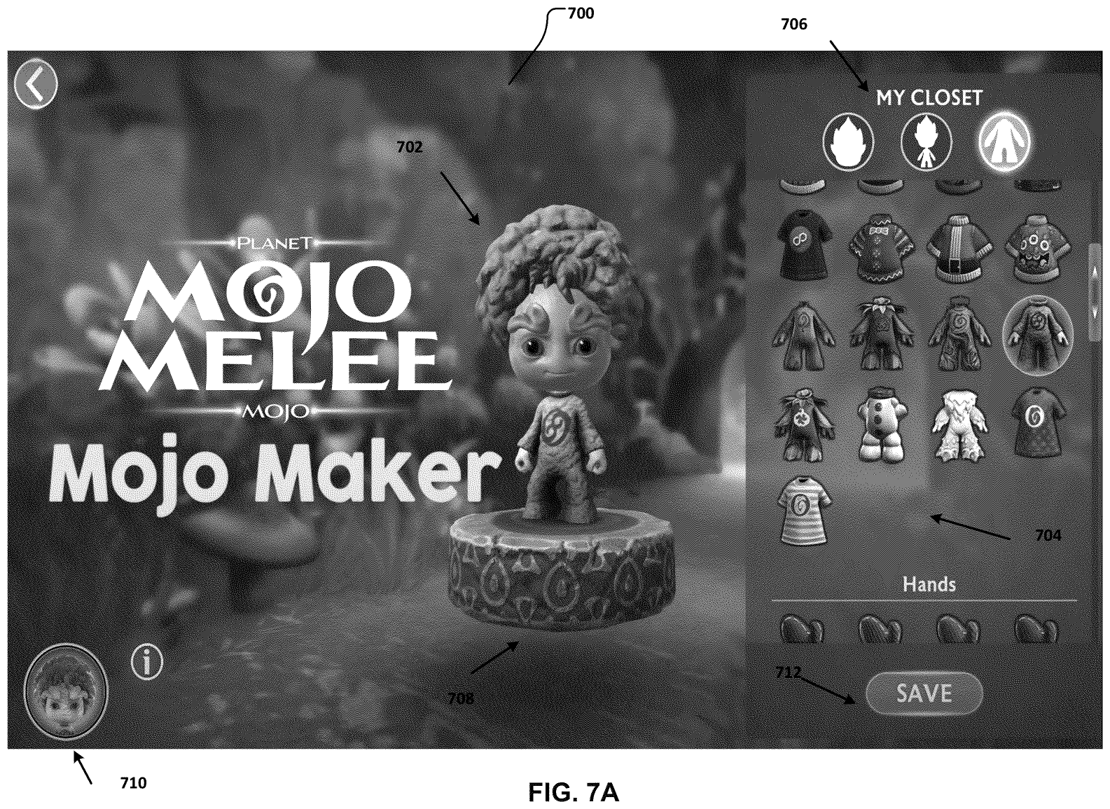

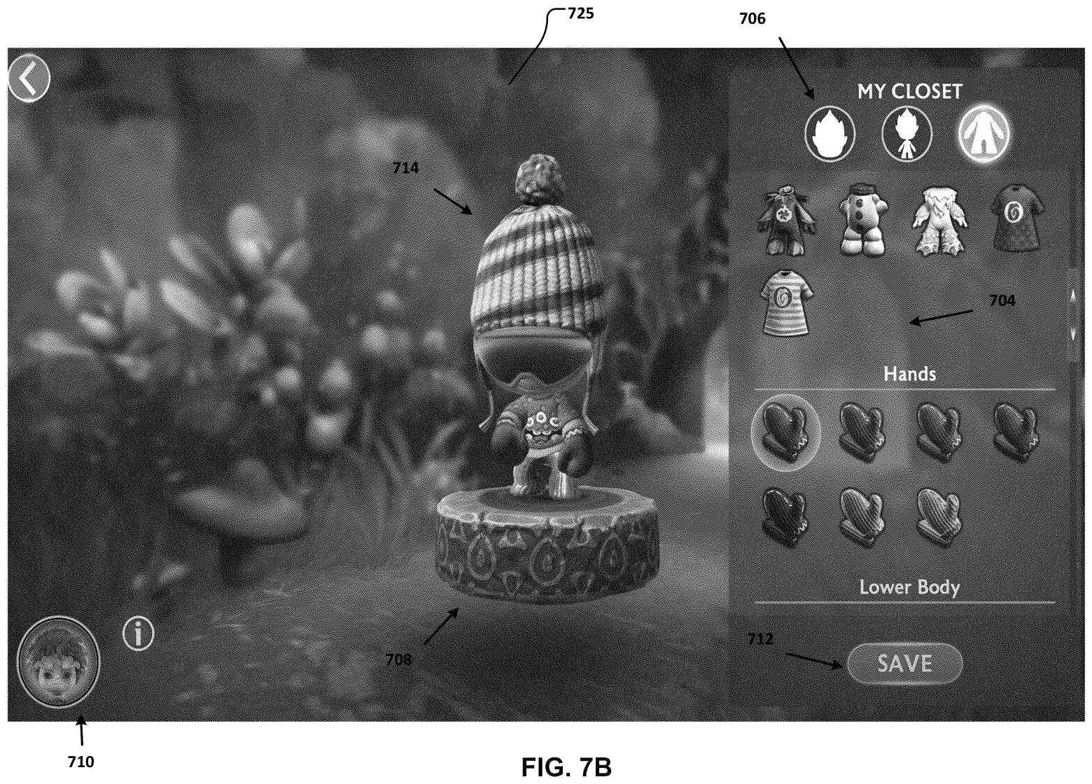

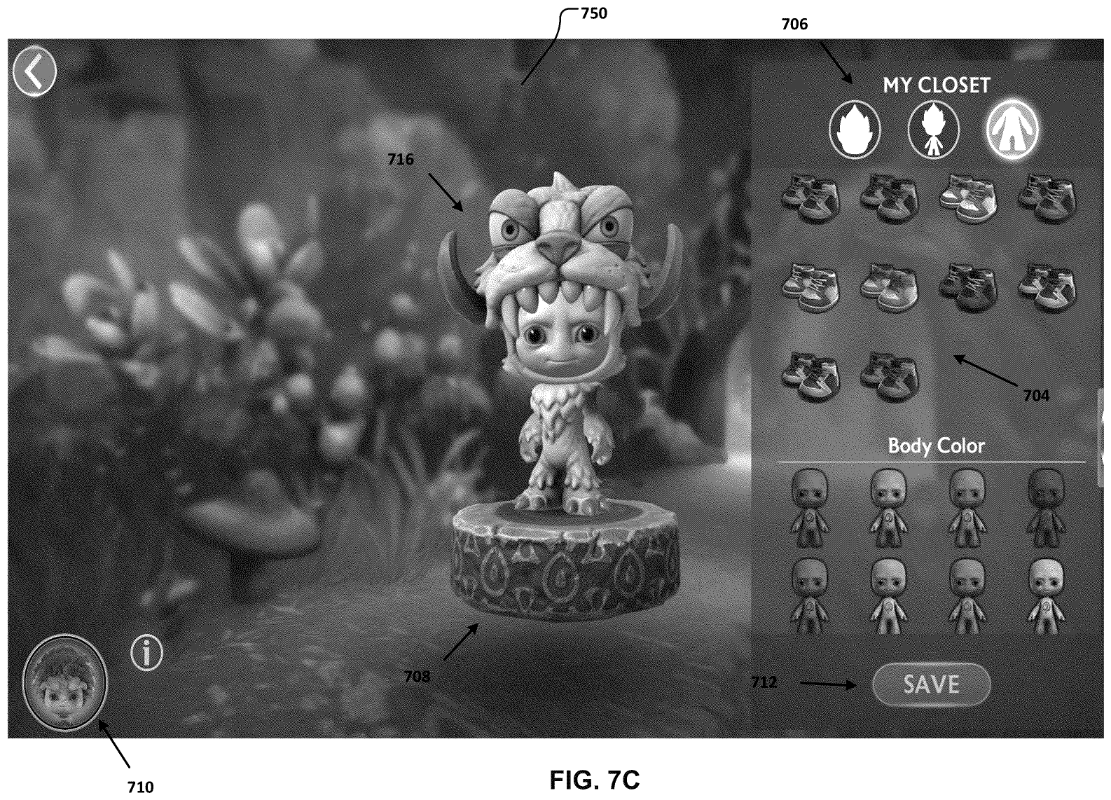

As previously introduced, a replacement and/or outcome NFT model, as will be shown in FIGS. 7B and 7C, can be entirely distinct from its corresponding initial NFT model, and will bear new identification on distributed ledger 210 to reflect as such. Changing and subsequently bearing new identification each time an initial NFT model undergoes one or more equip processes, such as 402 and 404, can ensure that user 202 and/or other persons viewing an outcome NFT model can have confidence relating to its set identification, and know that its accessories and/or metadata cannot change without undergoing the processes as described herein. Additionally, this can prevent bugs and fraud occurring when, for example, purchasing an NFT model on a digital marketplace. Without changing identification, a person might initiate the purchase of an NFT model for its certain properties (i.e. metadata) and/or accessories, but the NFT model they receive might not have these accessories and/or properties if an equip action was commenced in the meantime.

According to the present disclosure, equipping process 400 unfolds as the frontend 214, once engaged (402) by the user 202, calls the function “equip” (404) via WardrobeService 312 once the user 202 has selected one or more accessories to equip to their NFT model. Rendering these accessories and NFT models, and presenting them for user 202 manipulation, can be enabled via a backend database, such as Database 318, where metadata and/or identification information can be saved and accessed by users via computer system 204. According to some implementations, equip functions can include equipping and/or unequipping one or more additional accessories on a single initial NFT models to create an outcome NFT model. These functions may only be successful if user 202 is properly verified as “owning” the initial NFT model and associated accessories within their user/player wallet, as will be discussed later.

As shown in FIG. 4, once a user initiates frontend request 214 by, for example, equipping an accessory on their NFT model, a rendering is generated (406) via ModelGenerator 316 while in communication with Database 318. This rendering may be illustrated for the user 202 via their computer system 204. At this time, WardrobeService 304, in communication with MetadataService 314, may, update (408) and save (410) the metadata and/or identification of the NFT model to Database 318 to reflect the equipping and/or other changes made to the accessory of the NFT model. According to some implementations, once this is completed, and the NFT model is rendered visually via computer system 204 with one or more changes made to its accessories, WardrobeService 304 will sign (412) its approval of the transaction for it to proceed for authorization via distributed ledger 210. Individual signatures may be required for individual equipping requests prompted by user 202 at 214, as they may for when two or more signatures may be processed by WardrobeService 304 as part of a “bulk” request, whereby one or more changes are made relating to accessories. In some implementations, the system and methods described herein provide a deadline, which can be the UTC timestamp, for the expiration of the signature (412). This can ensure that the signed action (412) cannot be used after that timestamp. Specifically, each metadata may include a nonce, which is an auto-incremented number that will serve as replay protection. This can ensure that a signed action, such as (412), cannot be used more than once. For example, the v, r and s are the outputs of the ECDSA signature (412), which can be used by WardrobeContract 302 to confirm that WardrobeService 304, via its game wallet, has signed off on the equip action (404).

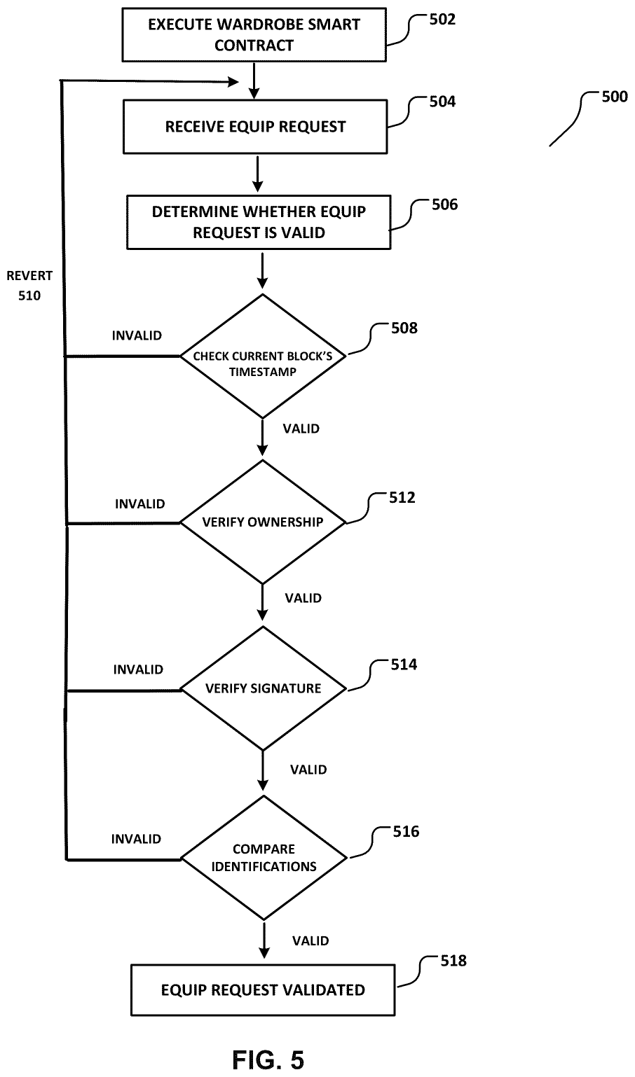

Also shown in FIG. 4, to continue with process 400, according to some implementations, a determination must be made via distributed ledger 210 if the equipping request initiated by user 202 is valid. Once WardrobeService 304 signs (412) its approval of the transaction, this action simultaneously serves (414) as frontend request (416) in communication with WardrobeContract 302. This may involve communications via network 206 with a Database 318 game wallet associated with the WardrobeContract 302, as WardrobeContract 302 determines via distributed ledger 210 if the approval (412) is valid for WardrobeService 304 to initiate. This will be discussed in more detail in FIG. 5.

As shown in FIG. 4, if the approval (412) is determined by WardrobeContract 302 to be valid, this can initiate one or more simultaneous process transactions (426), including the transfer (418) of the user's 202 initial NFT model, and the one or more additional accessories they have selected to equip, to the MojoPartContract 306. In some implementations, the MojoPartContract 306 stores, externally (via Database 318 or via another computer system in communication with network 206) or internally, via distributed ledger 210, the one or more additional accessories to be equipped to the initial NFT model prior to the generation of the outcome NFT model, donning one or more additional accessories. At this stage, WardrobeContract 302 can then send each of the unequipped one or more accessories back to the user 202 from the MojoPartContract 306 (not shown), send (420) the user's initial NFT model to a burn address, and generate/mint (422) the outcome NFT model, which can be sent to the user 202 and recorded via distributed ledger 210 and/or Database 318. For example, the outcome NFT model is generated from one or more associated games/applications relating to Database 318, and subsequently, the metadata can be derived from the current/outcome NFT model, its one or more accessories, and other respective attributes. In some implementations, the outcome NFT model may be otherwise generated. In some implementations, the equipped one or more accessories may stay in the custody WardrobeContract 302 until they are unequipped, as previously mentioned. A transaction receipt may also be generated (424) on distributed ledger 210 and provided to user 202, in addition to other means of recordation and/or notification. For example, after process 400 aggregates the equip actions (402), (404), (414), and (416), it then can create an Ethereum transaction (mint or bulkMint) for the user 202 to submit via their own digital wallet. This can ensure it is always the decision of user 202 on whether or not an action takes place, further protecting their digital assets, such as the non-fungible digital asset 208. According to some implementations, (414)-(424) can be completed as part of a single transaction.

FIG. 5 illustrates a block diagram of process 500, depicting an example validation process of an equipping transaction by WardrobeContract 302. According to example process 500, WardrobeContract 302 is executed (502) following the approval signing (412) of FIG. 4. WardrobeContract 302 receives (504) the equipping request (416) and determines (506) if the request (416) initiated by approval (412) is valid. Each step of process 500 can involve one or more communications across network 206. According to example process 500, to determine if equipping request (416) is valid, WardrobeContract 302 may first check (508) that the current block's timestamp via distributed ledger 210 is after the provided deadline, as previously discussed. For example, this may include a determination regarding if a sufficient and/or preset number of blockchain confirmations to achieve transaction finality is achieved. If it is, the transaction reverts (510) with, for example, an ExpiredSignature error. Next, ownership of the initial NFT model can be validated (512) to ensure user 202, via their wallet as recorded locally (via “cold” storage) or publicly (via distributed ledger 210), is the owner of the initial NFT model. If not, the transaction reverts (510) with, for example, a SenderIsNotOwner error. Next, the signature (412) can be verified (514) to determine if WardrobeService 304 of that signature has a set role, such as an EQUIPPER_ROLE, which can refer to a role assigned by WardrobeContract 302. In some implementations, this can include a gnosis-safe multi-sig digital wallet. If not, the transaction reverts (510) with another error message. Then, the metadata and/or identification of the initial NFT model can be compared (516) to what the outcome metadata and/or identification should be for a new, outcome NFT model (i.e. expectation of the same oldMetadataHash, oldEquippedPartIds and idEncoding Version). If the provided metadata and/or identification of the initial NFT model and the newly calculated expected metadata and/or identification do not match, then the transaction may revert (510) with, for example, an InvalidTokenId error. If process 500 progresses beyond each step, then the equip request (416) is validated (518).

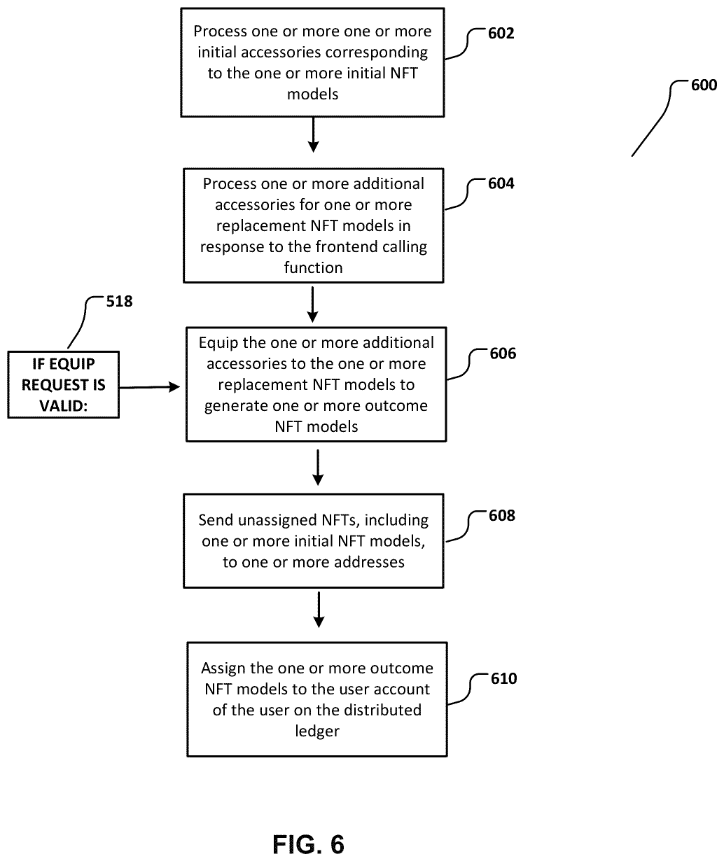

FIG. 6 illustrates a block diagram of process 600, depicting an example process following the validation of an equipping transaction by WardrobeContract 302. According to process 600, and as shown in FIG. 4, the WardrobeService 312, WardrobeContract 302, ModelGenerator 316, MetadataService 314, and/or Database 318 first process (602) the one or more one or more initial accessories corresponding to the one or more initial NFT models in providing an initial rendering to user 202 via computer system 204. For example, as previously discussed, the previous metadata and/or identification can be verified to have the correct partType (i.e., the last byte of the identification). If not, the transaction can revert with, for example, an InvalidPartId error. Continuing with the example for (602), the existence of the accessory with that identification can be checked; if the accessory does not exist (i.e., owned by the WardrobeService 304 initiating the equipping request), the transaction can reverts with, for example, a PartDoesNotExist error. Additionally, if the new accessory identification is not the same as the previous accessory identification, this can mean the previous accessory is transferred from WardrobeContract 302 to the digital wallet of user 202.

In some implementations, process 600 includes process (604), relating to illustrative, metadata and/or identification (but not via blockchain/distributed ledger 210) changes to their NFT model and/or its accessories made in response to the frontend calling function 214 by user 202. Continuing with the previous example, if the new identification is verified to have the correct accessory, referred to as partType (i.e., the last byte of the identification); if not, the transaction reverts with, for example, an InvalidPartId error. Then, if the new accessory identification is not the same as the previous accessory identification, the new accessory is equipped (606). For some implementations, WardrobeContract 302 checks if the accessory exists, and if it does, it transfers it from the digital wallet of user 202 to the WardrobeContract 302. If the accessory does not exist, the transaction reverts with, for example, a PartDoesNotExist error.

In some implementations, process 600 can include adding one or more additional accessories for one or more replacement NFT models, which can be generated as a placeholder rendering via computer system 204 at (410) prior to the equip request (416) being validated (518). If the equip request (416) is validated (518), WardrobeContract 302 can equip (606) the one or more additional accessories to the one or more replacement NFT models, rendered at (410), to generate/mint one or more outcome NFT models bearing different accessories and new metadata and/or identification than their respective initial NFT model, as introduced in (422) in FIG. 4. In some implementations, this outcome NFT model will be transferred (418) to MojoPartContract 306 in order to provide ownership transparency, as introduced previously. Process 600 can further include MojoContract 304 sending (608), initiated via a calling function from WardrobeContract 302 to MojoContract 304, unassigned NFT models and/or accessories, including one or more initial NFT models, to one or more addresses. For example, these addresses can include burn addresses, as shown in (420) in FIG. 4, storage addresses, or any address on a blockchain, such as 210. Process 600 can also include assigning (610) the one or more outcome NFT models to the digital wallet of the user 202 on the distributed ledger 210.

According to some implementations, equip functions can include bulk equipping and/or unequipping two or more additional accessories on a single initial NFT models to create an outcome NFT model. This can be valuable in both decreasing the number of transactions when processing multiple initial NFT models, while also minimizing the number of steps when the NFT models are “swapping” accessories during the creation of replacement, and subsequently, outcome NFT models. Further, this can greatly reduce both the transaction count as well as the gas (i.e. transaction fees related to the Ethereum blockchain network) costs across the distributed ledger 210.

FIGS. 7A-7C illustrate example renderings 700, 725, and 750 of initial and replacement NFT models, prior and following the addition of one or more accessories, as previously discussed. These renderings 700, 725, and 750 can be viewed by user 202 via computer system 204 while in communication with Database 318 via network 206, where they may be generated for user 202 manipulation, for example. As shown in FIG. 7A, initial NFT model 702 may be showcased on platform 708, which can be static or dynamic. If the user 202 wishes to browse across multiple initial NFT models 704, they can do so via icons 710 (of which only one is shown in each of FIGS. 7A-7C). User 202 can toggle through different regions of the body relating to initial NFT model 702 via closet 706, allowing for user 202 to make changes, such as equipping one or more additional accessories, to their desired region. These one or more additional accessories 704 can be browsed through, and can be equipped, saved via save button 712 as replacement NFT model 714, and signed (416) for approval, as previously discussed. If the initial NFT model 702 and the equipped one or more additional accessories 704 are validated as “owned” by user 202, their outcome NFT model (not shown, but identical to the replacement NFT model 714 visually) will be generated as previously discussed. While FIGS. 7B and 7C show renderings 725 and 750 of replacements NFT models 714 and 716, bearing different accessories which have been equipped, they can be visualized without being saved via save button 712 and/or approved (416), to provide user 202 or other users with a visualization of what an outcome NFT model may look like when equipped with one or more additional accessories 704.

These accessories 704 can include, but are not limited to: clothing, handheld items, weapons, skins, textures, animations, environments, audio, visual effects, and/or other contemplated attributes that a user 202 may desire to alter. In some implementations, these NFT models can be a character avatar in 3D implementations, as shown in FIGS. 7A-7C. In some implementations, these NFT models can be made to wear a hat where previously no hat was worn, or to instead replace a previous hat. In some implementations, the replacement and/or outcome NFT model, with differentiated metadata from the initial NFT model, as previously discussed. These initial NFT models may be accessible via a marketplace in communication with network 206, Database 318, and/or distributed ledger 210 for other users to browse and/or purchase. In some implementations, these one or more initial NFTs, depending upon how many times user 202 has chosen to introduce and/or alter accessories 704, can be stored until the event that they may be sold alongside the newest altered iteration of the initial NFT model, or separately. Alternatively, these one or more initial NFTs can be burned by the user 202 maintaining ownership via their digital wallet and/or distributed ledger 210 over the newest altered iteration of the initial NFT model.

Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

Other implementations not specifically described in this specification are also within the scope of the following claims.

What is claimed is:

1. A computer-implemented method for generating a non-fungible token (NFT), comprising:
maintaining, by a set of node devices, a distributed ledger and a wardrobe smart contract that corresponds to one or more initial NFT models;
executing, by a set of node devices, the wardrobe smart contract in response to a frontend calling function, wherein the one or more initial NFT models are generated prior to the frontend calling function;
processing one or more one or more initial accessories corresponding to the one or more initial NFT models;
processing one or more additional accessories for one or more replacement NFT models in response to the frontend calling function;
receiving, by the wardrobe smart contract, an equipping request from a user account associated with a user;
determining, by the wardrobe smart contract, whether the equipping request is valid,
wherein, if the equipping request is valid, the wardrobe smart contract equips the one or more additional accessories to the one or more replacement NFT models to generate one or more outcome NFT models;
sending unassigned NFTs, including one or more initial NFT models, to one or more addresses; and
assigning, by the wardrobe smart contract, the one or more outcome NFT models to the user account of the user on the distributed ledger.

2. The method of claim 1, wherein determining whether the equipping request is valid, processing one or more initial accessories corresponding to the one or more initial NFT models, processing one or more additional accessories for one or more replacement NFT models in response to the frontend calling function, generating one or more outcome NFT models, and sending unassigned NFTs includes a single transaction.

3. The method of claim 1, wherein the one or more initial, replacement, and outcome NFT models include a shared plurality of different types of NFT models.

4. The method of claim 3, wherein the one or more replacement NFT models are generated prior to the frontend calling function.

5. The method of claim 3, wherein the one or more additional accessories are generated in response to the frontend calling function.

6. The method of claim 1, wherein the one or more additional accessories for one or more replacement NFT models are transferred from the user account associated with a user

7. The method of claim 1, wherein the wardrobe smart contract includes a plurality of one or more additional accessories to replace one or more of initial accessories in combination with the one or more initial NFT models if the equipping request is valid.

8. The method of claim 1, wherein the equipping request is determined to be valid by the wardrobe smart contract by checking that a current block's timestamp is after a provided deadline by a backend nonce function.

9. The method of claim 1, wherein the one or more addresses includes one or more burn addresses.

10. The method of claim 1, wherein the one or more addresses includes one or more smart contracts.

11. The method of claim 1, wherein the one or more initial accessories and one or more additional accessories are NFTs.

12. A computer-implemented system, comprising:
a digital processing device comprising:
at least one processor;
an operating system configured to perform executable instructions;
a memory; and
a computer program including instructions executable by the digital processing device to perform a method for generating a non-fungible token (NFT), the method comprising:
maintaining, by a set of node devices, a distributed ledger and a wardrobe smart contract that corresponds to one or more initial NFT models;
executing, by a set of node devices, the wardrobe smart contract in response to a frontend calling function, wherein the one or more initial NFT models are generated prior to the frontend calling function;
processing one or more one or more initial accessories corresponding to the one or more initial NFT models;
processing one or more additional accessories for one or more replacement NFT models in response to the frontend calling function;
receiving, by the wardrobe smart contract, an equipping request from a user account associated with a user;
determining, by the wardrobe smart contract, whether the equipping request is valid,
wherein, if the equipping request is valid, the wardrobe smart contract equips the one or more additional accessories to the one or more replacement NFT models to generate one or more outcome NFT models;
sending unassigned NFTs, including one or more initial NFT models, to one or more addresses; and
assigning, by the wardrobe smart contract, the one or more outcome NFT models to the user account of the user on the distributed ledger.

13. The method of claim 12, wherein determining whether the equipping request is valid, processing one or more initial accessories corresponding to the one or more initial NFT models, processing one or more additional accessories for one or more replacement NFT models in response to the frontend calling function, generating one or more outcome NFT models, and sending unassigned NFTs includes a single transaction.

14. The system of claim 12, wherein the one or more initial, replacement, and outcome NFT models include a shared plurality of different types of NFT models.

15. The system of claim 13, wherein the one or more replacement NFT models are generated prior to the frontend calling function.

16. The system of claim 13, wherein the one or more additional accessories are generated in response to the frontend calling function.

17. The system of claim 12, wherein the wardrobe smart contract includes a plurality of one or more additional accessories to replace one or more of initial accessories in combination with the one or more initial NFT models if the equipping request is valid.

18. The system of claim 12, wherein the equipping request is determined to be valid by the wardrobe smart contract by checking that a current block's timestamp is after a provided deadline by a backend nonce function.

19. The system of claim 12, wherein the one or more addresses includes one or more burn addresses and/or one or more smart contracts.

20. The system of claim 12, wherein the one or more initial accessories and one or more additional accessories are NFTs.
